(19) United States
(12) Patent Application Publication
(10) Pub. No.: US 2005/0048447 A1
(43) Pub. Date: Mar. 3, 2005

(54) Learning system and method of trading financial products

(76) Inventors: Chih-Ming Chiang, Junghe City (TW); Feng-Chih Chang, Taipei City (TW)

Correspondence Address: WILLIAM H. EILBERG, THREE BALA PLAZA, SUITE 501 WEST, BALA CYNWYD, PA, 19004, US

(21) Appl. No.: 10/722,497

(22) Filed: Nov. 28, 2003

(30) Foreign Application Priority Data
Aug. 29, 2003 (TW) 092123865

(51) Int. Cl. A63F 13/00; G06F 19/00; G06F 17/00

(52) U.S. Cl. 434/107; 463/9

(57) ABSTRACT

The present invention provides a learning system and method of trading financial products. The learning system comprises a trading device, a data processor, a user trading history device, and an experience-sharing device. The user trading history device further comprises a trading journal, an analyzer for specific targets, and a trading-rules updating device. The trend analysis diagrams and the trading experience provided by the user and fellow users are integrated into the learning system and method of trading financial products. The learning system and method of trading financial products records the entire financial products trading process and allows the user to track the scenes at any given trading moment, thereby strengthening the user's memory. Through performance analyses for specific targets, the user can summarize his trading strategies for future references. Through the experience-sharing device, the user can review fellow users trading history and performance and adopt their experience in future trading. By offering personal trading history and fellow users' experience, the system thus provides users with feedback mechanisms while learning the trading of financial products.

### FIELD OF INVENTION

The present invention relates to a learning system and method of trading financial products and in particular to one that integrates user trading database, financial products trend analysis diagrams, user trading history, and fellow users trading history.

### BACKGROUND OF INVENTION

Prior art learning system and method of trading financial products mainly provide information. Exemplified by YAHOO and SINA, portal providers offer information board containing stock news, individual stock information, trend analyses and accounts keeping, etc. Missing three key factors to learning: memories, thinking and feedback, the E-Stock website at http://www.e-stock.com.tw provides trading contests that, unfortunately, lacks learning effects that would allow tracking user trading history and analyzing reasons for success or failure.

Hence, the present invention provides a learning system and method of trading financial products in order to resolve the deficiencies that exist in prior arts.

### SUMMARY OF INVENTION

The present invention provides a learning system and method of trading financial products by furnishing financial products trading journal, an analyzer for specific targets, and an trading-rules updating device. The present invention incorporates user trading database, trend analysis diagrams, individual trading history, and fellow users trading history into a website, thus forming a learning system and method of trading financial products.

Therefore, it is an object of the present invention to provide a learning system and method to simulate trading of financial products.

It is another object of the present invention to provide a learning system and method of trading financial products having three key factors to learning: memories, thinking and feedback.

It is a further object of the present invention to provide a learning system and method of trading financial products having an analyzer for specific targets.

It is a further object of the present invention to provide a learning system and method of trading financial products having a users' experience-sharing mechanism.

It is yet a further object of the present invention to provide a learning system and method of trading financial products having trading rules with auto-updating, sharing and incorporating mechanisms.

### BRIEF DESCRIPTION OF DRAWINGS

FIG. 1A and FIG. 1B are the prospective view and flowchart of the learning system of trading financial products having closed trading rules and closed account position according to the first embodiment of the present invention.

FIG. 2A and FIG. 2B are the prospective view and flowchart of the learning system of trading financial products having open trading rules and closed account position according to the second embodiment of the present invention

FIG. 3A and FIG. 3B are the prospective view and flowchart of the learning system of trading financial products (hereafter learning system) 10 having closed trading rules and non-closed account position according to the third embodiment of the present invention.

FIG. 4A and FIG. 4B are the prospective view and flowchart of the learning system of trading financial products having open trading rules and account in non-closed account position according to the fourth embodiment of the present invention.

### DETAILED DESCRIPTIONS OF PREFERRED EMBODIMENTS

The following descriptions of the present invention should be referred to the accompanying drawings. Persons skilled in the art should realize that the following descriptions are provided for exemplary purposes rather than limiting the scope of the present invention.

In four embodiments that follow, a learning system and method of trading financial products of the present invention comprises a trading device, a data processor, a user trading history device, and an experience-sharing device. The user trading history device further comprises a trading journal, an analyzer for specific targets, and a trading-rules updating device.

A user trades financial products by utilizing a trading device. He can add or revise his own trading rules via the trading-rules updating device. Having the option of opening his trading rules to fellow users, the user can adopt fellow users' trading rules. The data processor generates the users' daily trading results, having daily transaction price of individual financial products, while the financial products trading journal continuously records the users' daily trading history. The user is able to analyze his or fellow users' trading performance and historical records via the analyzer for specific targets. When the trading performance is less than satisfactory, the user can opt for clearing the inventory and restarting trading. The user can access and adopt fellow users trading history via the experience-sharing device. The user obtains a positive learning effect from those fellow users' having good performance. Conversely, the user gets a negative learning effect from those fellow users' having bad performance.

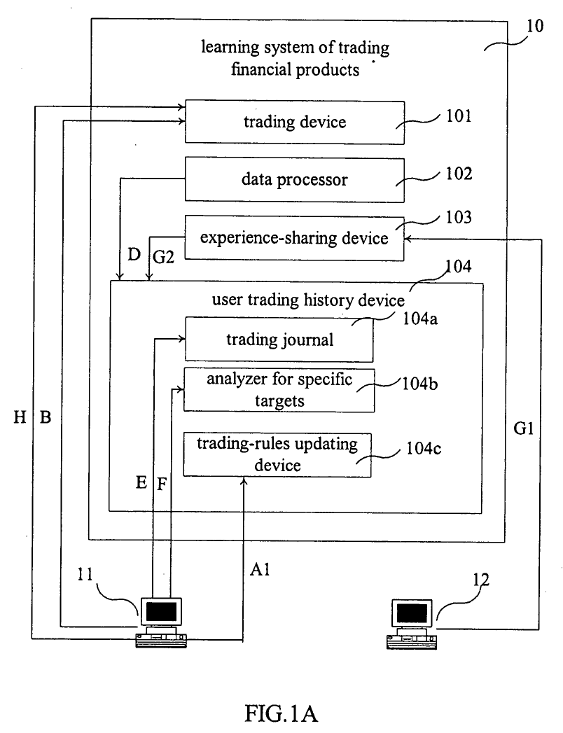

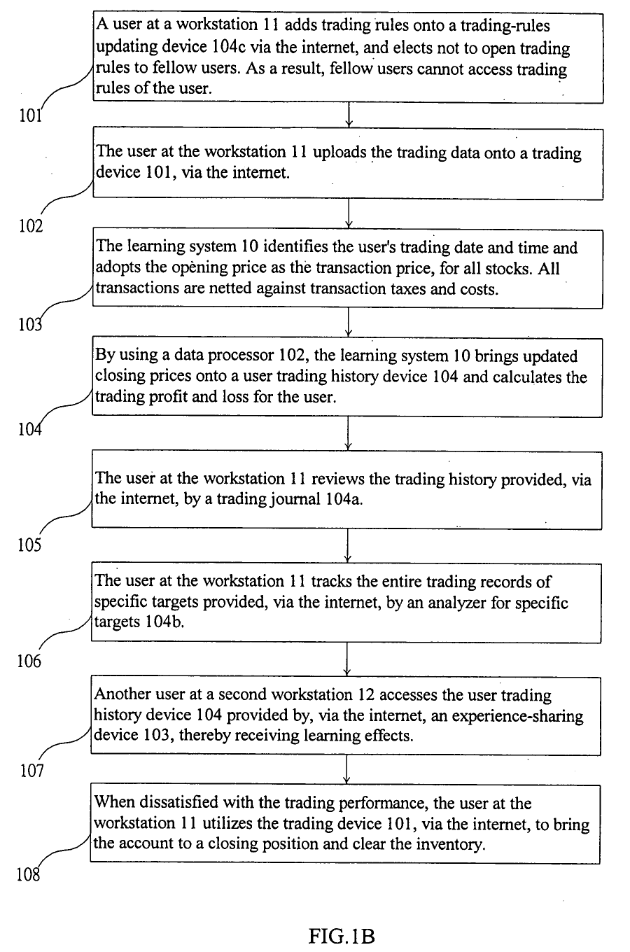

In the following context, the internet represents the internet, the intranet, or the combination of both. For brevity, the internet is not revealed in FIG. 1 through FIG. 4. The learning system of trading financial products may be an electronic trading platform.

First Embodiment

FIG. 1A and FIG. 1B are the prospective view and flowchart of the learning system of trading financial products (hereafter learning system) 10 having closed trading rules and closed account position according to the first embodiment of the present invention, comprising:

Step A in FIG. 1A (Step 101 in FIG. 1B): A user at a workstation 11 adds trading rules onto a trading-rules updating device 104c via the internet, and elects not to open trading rules to fellow users,. hence the term closed trading rules (Step A1). As a result, fellow users cannot access trading rules of the user (Step A2 not shown in FIG. 1A).

Step B in FIG. 1A (Step 102 in FIG. 1B): The user at the workstation 11 uploads the trading data onto a trading device 101, via the internet.

Step C not shown in FIG. 1A (Step 103 in FIG. 1B): The learning system 10 identifies the user's trading date and time and adopts the opening price as the transaction price, for all stocks. All transactions are netted against transaction taxes and costs.

Step D in FIG. 1A (step 104 in FIG. 1B): By using a data processor 102, the learning system 10 brings updated closing prices onto a user trading history device 104 and calculates the trading profit and loss for the user.

Step E in FIG. 1A (step 105 in FIG. 1B): The user at the workstation 11 reviews the trading history provided, via the internet, by a trading journal 104a.

Step F in FIG. 1A (step 106 in FIG. 1B): The user at the workstation 11 tracks the entire trading records of specific targets provided, via the internet, by an analyzer for specific targets 104b.

Step G in FIG. 1A (Step 107 in FIG. 1B): Another user at a second workstation 12 accesses the user trading history device 104 (Step G2) provided by, via the internet, an experience-sharing device 103 (Step G1), thereby receiving learning effects.

Step H in FIG. 1A (Step 108 in FIG. 1B): When dissatisfied with the trading performance, the user at the workstation 11 utilizes the trading device 101, via the internet, to bring the account to a closing position and clear the inventory.

Second Embodiment

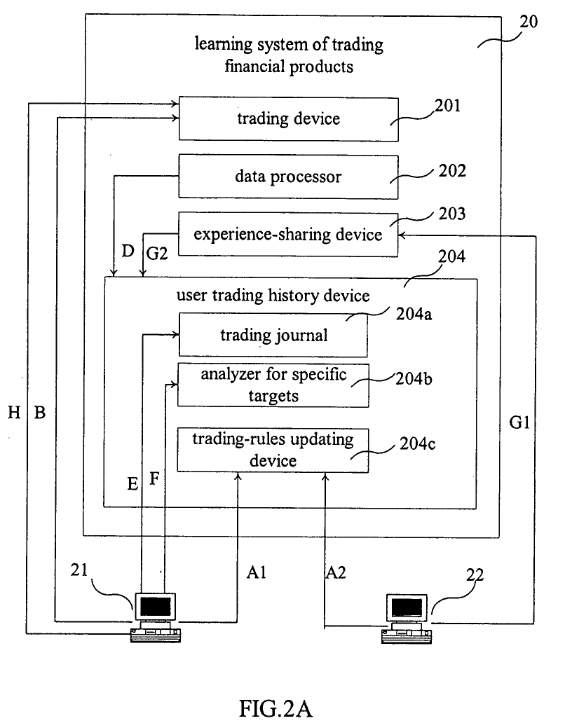

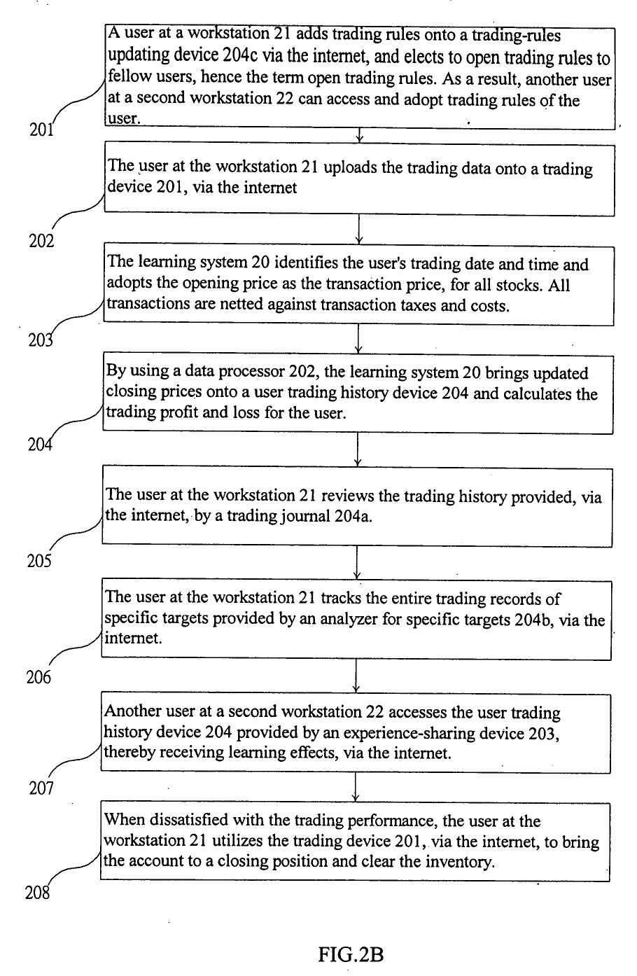

FIG. 2A and FIG. 2B are the prospective view and flowchart of the learning system of trading financial products (hereafter learning system) 20 having open trading rules and closed account position according to the second embodiment of the present invention, comprising:

Step A in FIG. 2A (Step 201 in FIG. 2B): A user at a workstation 21 adds trading rules onto a trading-rules updating device 204c via the internet, and elects to open trading rules to fellow users, hence the term open trading rules (Step A1). As a result, another user at a second workstation 22 can access and adopt trading rules of the user.

Step B in FIG. 2A (Step 202 in FIG. 2B): The user at the workstation 21 uploads the trading data onto a trading device 201, via the internet.

Step C not revealed in FIG. 2A (Step 203 in FIG. 2B): The learning system 20 identifies the user's trading date and time and adopts the opening price as the transaction price, for all stocks. All transactions are netted against transaction taxes and costs.

Step D in FIG. 2A (Step 204 in FIG. 2B): By using a data processor 202, the learning system 20 brings updated closing prices onto a user trading history device 204 and calculates the trading profit and loss for the user.

Step E in FIG. 2A (Step 205 in FIG. 2B): The user at the workstation 21 reviews the trading history provided, via the internet, by a trading journal 204a.

Step F in FIG. 2A (Step 206 in FIG. 2B): The user at the workstation 21 tracks the entire trading records of specific targets providedby an analyzer for specific targets 204b, via the internet.

Step G in FIG. 2A (Step 207 in FIG. 2B): Another user at a second workstation 22 accesses the user trading history device 204 (Step G2) provided byan experience-sharing device 203 (Step G1), thereby receiving learning effects, via the internet.

Step H in FIG. 2A (Step 208 in FIG. 2B): When dissatisfied with the trading performance, the user at the workstation 21 utilizes the trading device 201, via the internet, to bring the account to a closing position and clear the inventory.

Third Embodiment

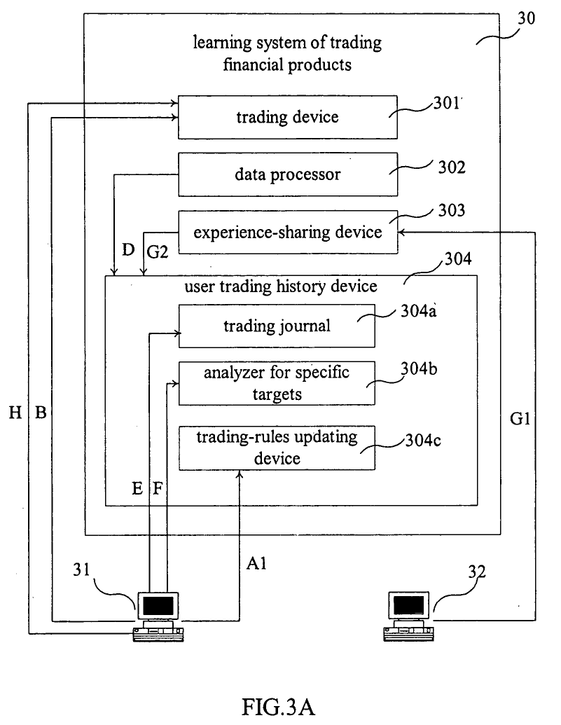

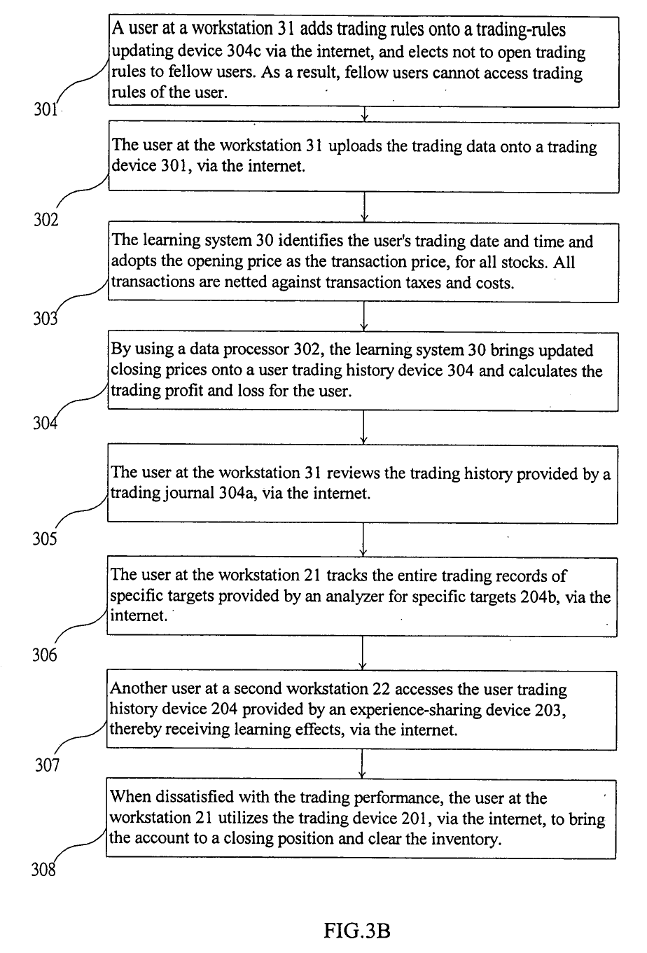

FIG. 3A and FIG. 3B are the prospective view and flowchart of the learning system of trading financial products (hereafter learning system) 10 having closed trading rules and non-closed account position according to the third embodiment of the present invention, comprising:

Step A in FIG. 3A (Step 301 in FIG. 3B): A user at a workstation 31 adds trading rules onto a trading-rules updating device 304c via the internet, and elects not to open trading rules to fellow users, hence the term closed trading rules (Step A1). As a result, fellow users cannot access trading rules of the user (Step A2 not shown in FIG. 3A).

Step B in FIG. 3A (step 302 in FIG. 3B): The user at the workstation 31 uploads the trading data onto a trading device 301, via the internet.

Step C not revealed in FIG. 3A (Step 303 in FIG. 3B): The learning system 30 identifies the user's trading date and time and adopts the opening price as the transaction price, for all stocks. All transactions are netted against transaction taxes and costs.

Step D in FIG. 3A (Step 304 in FIG. 3B): By using a data processor 302, the learning system 30 brings updated closing prices onto a user trading history device 304 and calculates the trading profit and loss for the user.

Step E in FIG. 3A (Step 305 in FIG. 3B): The user at the workstation 31 reviews the trading history provided by a trading journal 304a, via the internet.

Step F in FIG. 3A (Step 306 in FIG. 3B): The user at the workstation 31 tracks the entire trading records of specific targets provided by an analyzer for specific targets 304b, via the internet.

Step G in FIG. 3A (Step 307 in FIG. 3B): Another user at a second workstation 32 accesses the user trading history device 304 (Step G2) provided by, via the internet, an experience-sharing device 303 (Step G1), thereby receiving learning effects.

Step H in FIG. 3A (Step 308 in FIG. 3B): Being satisfied with the trading performance, the user at the workstation 31 utilizes the trading device 301 for continued trading.

Fourth Embodiment

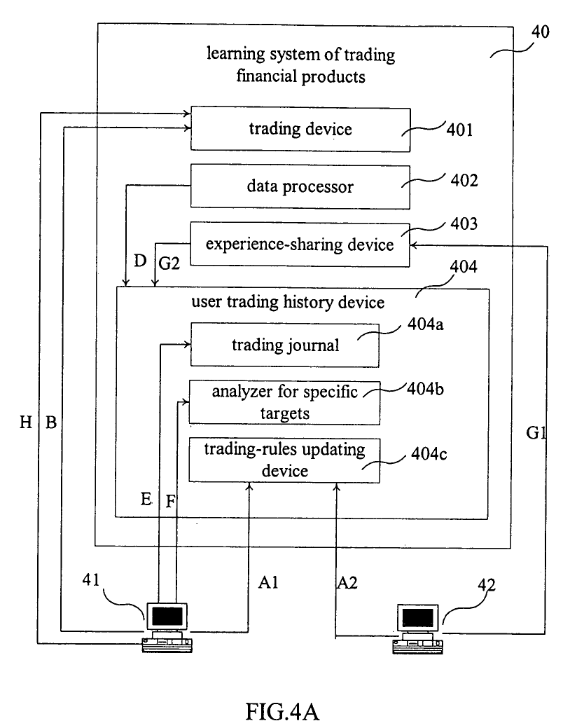

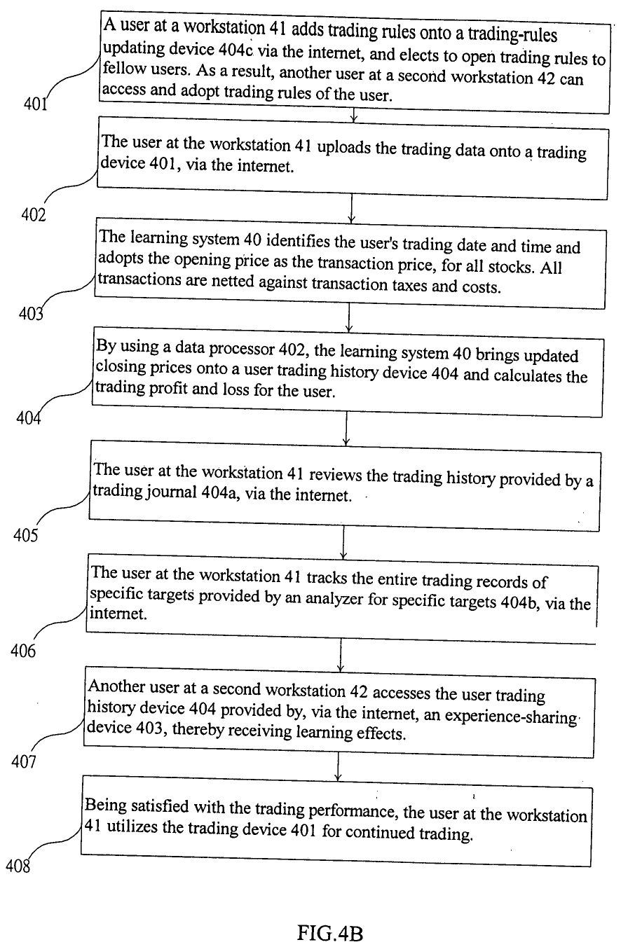

FIG. 4A and FIG. 4B are the prospective view and flowchart of the learning system of trading financial products (hereafter learning system) 40 having open trading rules and account in non-closing position according to the fourth embodiment of the present invention, comprising:

Step A in FIG. 4A (Step 401 in FIG. 4B): A user at a workstation 41 adds trading rules onto a trading-rules updating device 404c via the internet, and elects to open trading rules to fellow users, hence the term open trading rules (Step A1). As a result, another user at a second workstation 42 can access and adopt trading rules of the user.

Step B in FIG. 4A (Step 402 in FIG. 4B): The user at the workstation 41 uploads the trading data onto a trading device 401, via the internet.

Step C not revealed in FIG. 4A (Step 403 in FIG. 4B): The learning system 40 identifies the user's trading date and time and adopts the opening price as the transaction price, for all stocks. All transactions are netted against transaction taxes and costs.

Step D in FIG. 4A (Step 404 in FIG. 4B): By using a data processor 402, the learning system 40 brings updated closing prices onto a user trading history device 404 and calculates the trading profit and loss for the user.

Step E in FIG. 4A (Step 405 in FIG. 4B): The user at the workstation 41 reviews the trading history provided by a trading journal 404a, via the internet.

Step F in FIG. 4A (Step 406 in FIG. 4B): The user at the workstation 41 tracks the entire trading records of specific targets provided by an analyzer for specific targets 404b, via the internet.

Step G in FIG. 4A (Step 407 in FIG. 4B): Another user at a second workstation 42 accesses the user trading history device 404 (Step G2) provided by, via the internet, an experience-sharing device 403 (Step G1), thereby receiving learning effects.

Step H in FIG. 4A (Step 408 in FIG. 4B): Being satisfied with the trading performance, the user at the workstation 41 utilizes the trading device 401 for continued trading.

According to the embodiments of the present invention, the learning system and method of trading financial products records the entire financial products trading process and allows the user to track the scenes at any given trading moment. The user can also strengthen his memory by integrating the trading history of many users and the financial products financial products trend analysis chart. Through performance analyses for specific targets, the user can summarize his trading strategies for future references. Through the experience-sharing device, the user can review fellow users trading history and performance and adopt their experience in future trading. By offering personal trading history and fellow users' experience, the system thus provides users with feedback mechanisms while learning the trading of financial products.

To recap, the present invention offers learning effects having three key factors of learning process: memories, thinking, and feedback not to be found in such prior art websites YAHOO, SINA, or E-Stock. While the present invention has been described in terms of several preferred embodiments, various alternatives and modifications can be devised by those skilled in the art without departing from the invention. Accordingly, the present invention is intended to embrace all such alternatives that fall within the scope of the claims.

1. A learning system of trading financial products, comprising:
a trading device that allows a user at a workstation to enter trading data for trading financial products, via the internet; and
a user trading history device that records the user's trading process in the trading device.

2. The learning system of trading financial products as in claim 1, wherein the user trading history device provides learning effects.

3. The learning system of trading financial products as in claim 2, wherein the user trading history device further comprises a trading journal that records the user's entire trading process in the trading device so that the user can review the trading history via the internet.

4. The learning system of trading financial products as in claim 1, wherein the user utilizes the trading device, via the internet to bring the account to a closing position and clear the inventory.

5. The learning system of trading financial products as in claim 2, wherein the user trading history device further comprises an analyzer for specific targets that analyzes the user's trading process in the trading device.

6. The learning system of trading financial products as in claim 5, wherein the user tracks the entire history of specific targets by using the analyzer for specific targets.

7. The learning system of trading financial products as in claim 1, wherein the user trading history device further comprise a trading-rules updating device that updates the user's trading rules.

8. The learning system of trading financial products as in claim 7, wherein the user utilizes the trading-rules updating device to open trading rules to fellow users.

9. The learning system of trading financial products as in claim 7, wherein the user utilizes the trading-rules updating device not to open trading rules to fellow users.

10. The learning system of trading financial products as in claim 8, wherein fellow users reviews the trading-rules updating device on the trading-rules updating device.

11. The learning system of trading financial products as in claim 10, wherein fellow users adopts the trading-rules updating device on the trading-rules updating device.

12. The learning system of trading financial products as in claim 1, further comprising a data processor that brings updated closing prices onto a user trading history device and calculates the trading profit and loss for the user.

13. The learning system of trading financial products as in claim 12, wherein the data processor generates the users' daily trading results having daily transaction price of individual financial products.

14. The learning system of trading financial products as in claim 1, further comprising an experience-sharing device that provides fellow users trading history to the user.

15. A learning method of trading financial products, comprising:
b. a user at a workstation uploads the trading data onto a trading device, via the internet; and
e. the user reviews the trading history provided by a trading journal, via the internet.

16. The learning method of trading financial products as in claim 15, further comprising:
a. the user at the workstation adds trading rules onto a trading-rules updating device, via the internet.

17. The learning method of trading financial products as in claim 16, further comprising:
a1. the user at the workstation opens trading rules to fellow users.

18. The learning method of trading financial products as in claim 17, further comprising:
a2. fellow users at a second workstation accesses and adopts trading rules of the user.

19. The learning method of trading financial products as in claim 16, further comprising the following steps:
a3. the user at the workstation chooses not to open trading rules to fellow users.

20. The learning method of trading financial products as in claim 15, further comprising:
c. providing a learning system of trading financial products that identifies the user's trading date and time, and adopts the opening price as the transaction price such that the transactions are netted against transaction taxes and costs.

21. The learning method of trading financial products as in claim 15, further comprising:
d. providing a data processor of a learning system of trading financial products that brings updated closing prices onto a user trading history device and calculates the trading profit and loss for the user.

22. The learning method of trading financial products as in claim 15, further comprising:
f. the user at the workstation tracks the entire trading records of specific targets provided by an analyzer for specific targets, via the internet.

23. The learning method of trading financial products as in claim 15, further comprising:
g. Another user at a second workstation accesses the user trading history device provided by, via the internet, an experience-sharing device, thereby receiving learning effects.

24. The learning method of trading financial products as in claim 15, further comprising:
h1. the user at the workstation 11 utilizes the trading device, via the internet, to bring the account to a closing position and clear the inventory

25. The learning method of trading financial products as in claim 15, further comprising:
h2. the user at the workstation utilizes continue to trade on the trading device.
